(19) United States
(12) Patent Application Publication
(10) Pub. No.: US 2013/0162692 A1
(43) Pub. Date: Jun. 27, 2013

(54) LUMINANCE TEST SYSTEM AND METHOD FOR LIGHT EMITTING DIODES

(71) Applicant: KANG-BIN WANG, Shenzhen City (CN)

(72) Inventor: KANG-BIN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/611,093

(22) Filed: Sep. 12, 2012

(30) Foreign Application Priority Data
Dec. 27, 2011 (CN) 201110444040.1

(51) Int. Cl. G09G 3/32; G09G 5/10

(52) U.S. Cl. 345/690; 345/82

(57) ABSTRACT

A luminance test system includes a plurality of LEDs, a microcontroller, a plurality of light sensors, a plurality of shielding members, a plurality of AD converters, a MCU and a display module. Each of the plurality of light sensors detects a luminance of one of the plurality of LEDs to generate an analog luminance signal. Each of the shielding members receives one of the plurality of LEDs and one of the plurality of light sensors. Each of the plurality AD converters converts the analog luminance signal into a digital luminance signal. The plurality of AD converters in turn transmit the digital luminance signal to the MCU. The display module displays a luminance value of each of the plurality of LEDs according to the digital luminance signal.

### BACKGROUND

1. Technical Field

The present disclosure relates to luminance test systems and methods, and particularly to a luminance test system and method for testing a plurality of light emitting diodes.

2. Description of Related Art

Light-emitting diode (LED) is widely used in many applications because of LED's high-luminance, low-energy, and long life. Due to the difference in the optical properties of each individual LED, a plurality of LEDs may have different light intensities, and the display quality of the plurality of LEDS may not be appealing. Thus, before using the LED, the intensity of LED will be tested by a test system. However, known test systems can only test one LED at a time, therefore, the efficiencies of known test systems are generally low.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a luminance test system according to an embodiment.

FIG. 2 illustrates a detailed circuit diagram of the luminance test system of FIG. 1.

FIG. 3 is a schematic diagram of a shielding member.

FIG. 4 is similar to FIG. 3, but the shielding member receives a LED and a light sensor.

FIGS. 5A and FIGS. 5B are flow charts of a luminance test method according to an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

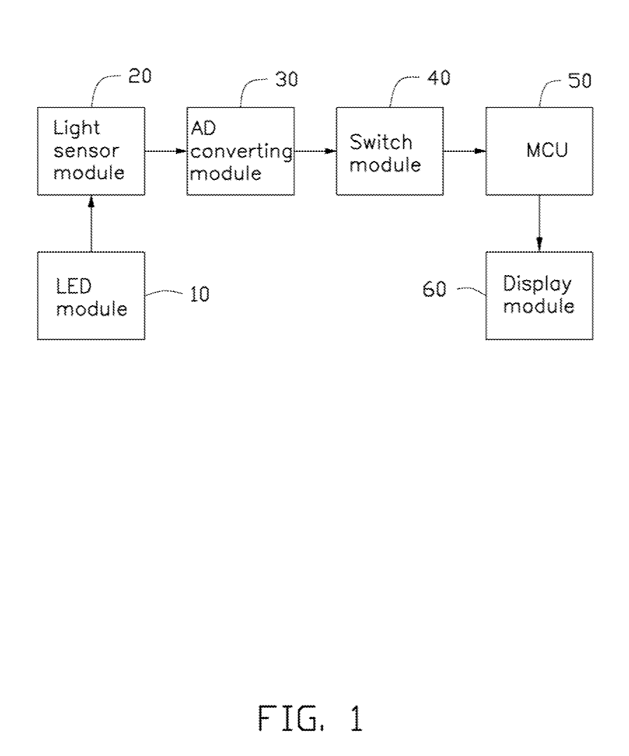

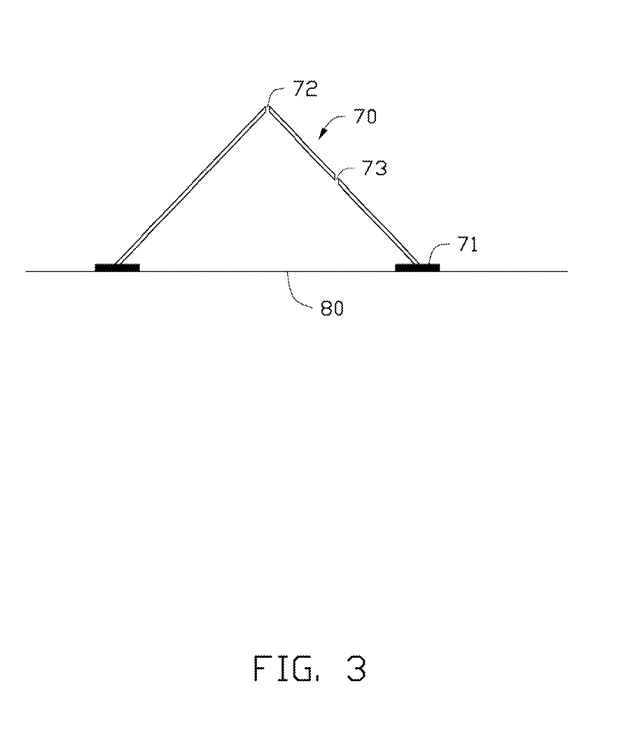

FIG. 1 shows a test system configured to detect a luminance of a LED module 10. The test system includes a light sensor module 20, an analog to digital (AD) converting module 30 connected to the light sensor module 20, a switch module 40 connected to the AD converting module 30, a microcontroller (MCU) 50 connected to the switch module 40, a display module 60 connected to the MCU 50, and a plurality of shielding members 70 (referring to FIG. 3).

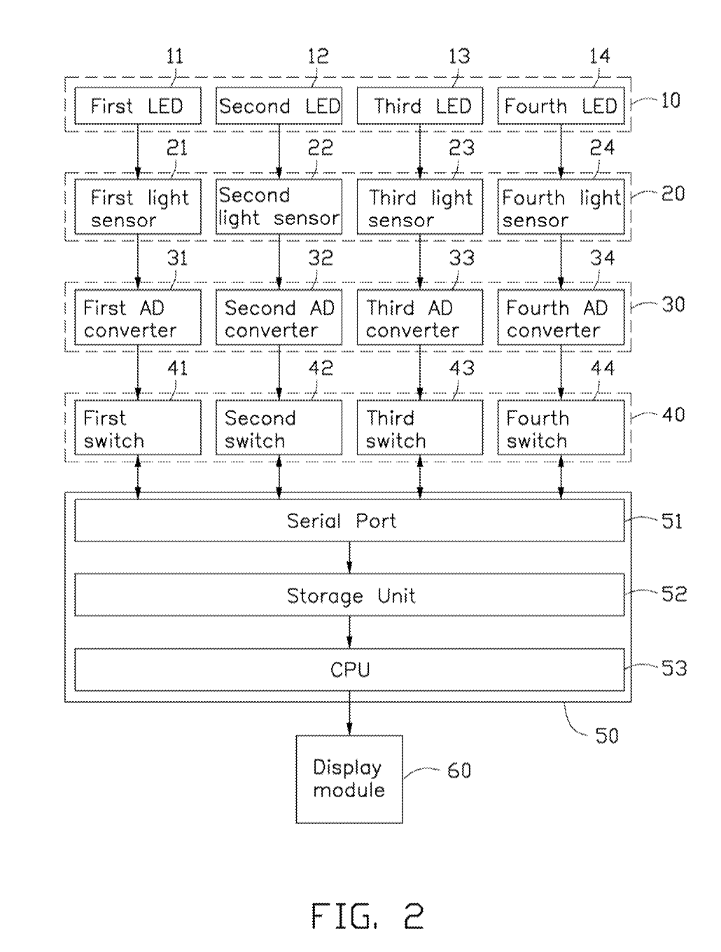

Referring to FIG. 2, the LED module 10 includes a plurality of LEDs, the light sensor module 20 includes a plurality of light sensors corresponding to the plurality of LEDs, the AD converting module 30 includes a plurality of AD converters corresponding to the plurality of light sensors, and the switch module 40 includes a plurality of switches corresponding to the plurality of AD converters. In one embodiment, the first LED module 10 includes a first LED 11, a second LED 12, a third LED 13, and a fourth LED 14. The light sensor module 20 includes a first light sensor 21, a second light sensor 22, a third light sensor 23, and a fourth light sensor 24. The AD converting module 30 includes a first AD converter 31, a second AD converter 32, a third AD converter 33, and a fourth AD converter 34. The switch module 40 includes a first switch 41, a second switch 42, a third switch 43, and a fourth switch 44.

The first light sensor 21 is configured to detect a luminance of the first LED 11 and generate an analog luminance signal. The first AD converter 31 is connected to the first light sensor 21. The first AD converter 31 is configured to convert the analog luminance signal into a digital luminance signal, which represents a luminance value of the first LED 11. The first switch 41 is connected between the first AD converter 31 and the MCU 50. The first AD converter 31 is configured to transmit the digital luminance signal to the MCU 50 when the first switch 41 is on.

The second LED 12, the second light sensor 22, the second AD converter 32, and the second switch 42 connect and work similar to those of the first LED 11, the first light sensor 21, the first AD converter 31, and the first switch 41. The third LED 13, the third light sensor 23, the third AD converter 33, and the third switch 43 connect and work similar to those of the first LED 11, the first light sensor 21, the first AD converter 31, and the first switch 41. The fourth LED 14, the fourth light sensor 24, the fourth AD converter 34, and the fourth switch 44 connect and work similar to those of the first LED 11, the first light sensor 21, the first AD converter 31, and the first switch 41.

The MCU 50 includes a serial port 51, a storage unit 52 connected to the serial port 51, and a Central Processing Unit (CPU) 53 connected to the storage unit 52. The display module 60 is connected to the CPU 53. Each of the first switch 41, the second switch 42, the third switch 43, and the fourth switch 44 is connected to the serial port 51. The MCU 50 is configured to control each of the first switch 41, the second switch 42, the third switch 43, and the fourth switch 44 to be on or off via the serial port 51. In one embodiment, the MCU 50 control one of the first switch 41, the second switch 42, the third switch 43, and the fourth switch 44 to be on and other three switches of the first switch 41, the second switch 42, the third switch 43, and the fourth switch 44 to be off at one time. For example, when the first switch 41 is controlled to be on, other three switches are controlled to be off, and the first AD converter 31 transmits the digital luminance signal, which represents the luminance value of the first LED 11, to the storage unit 52 via the first switch 41 and the serial port 51.

Further, the MCU 50 controls the first switch 41, the second switch 42, the third switch 43, and the fourth switch 44 to be turned on in order. In one embodiment, the first switch 41 is first to be turned on, the second switch 42 is second to be turned on, the third switch 43 is third to be turned on, and the fourth switch 43 is fourth to be turned on.

The storage unit 52 is configured to store the digital luminance signal. For example, the storage unit 52 stores a first digital luminance signal, which represents a luminance value of the first LED 11, in a first address of the storage unit 52. The storage unit 52 stores a second digital luminance signal, which represents a luminance value of the second LED 12, in a second address of the storage unit 52. The storage unit 52 stores a third digital luminance signal, which represents a luminance value of the third LED 13, in a third address of the storage unit 52. The storage unit 52 stores a fourth digital luminance signal, which represents a luminance value of the fourth LED 14, in a fourth address of the storage unit 52. The CPU 53 is configured to read the digital luminance signals from the storage unit 52 and transmit the digital luminance signals to the display module 60. The display module 60 is configured to display luminance values of the first LED 11, the second LED 12, the third LED 13, and the fourth LED 14 according to the first digital luminance signal, the second digital luminance signal, the third digital luminance signal, and the fourth digital luminance signal.

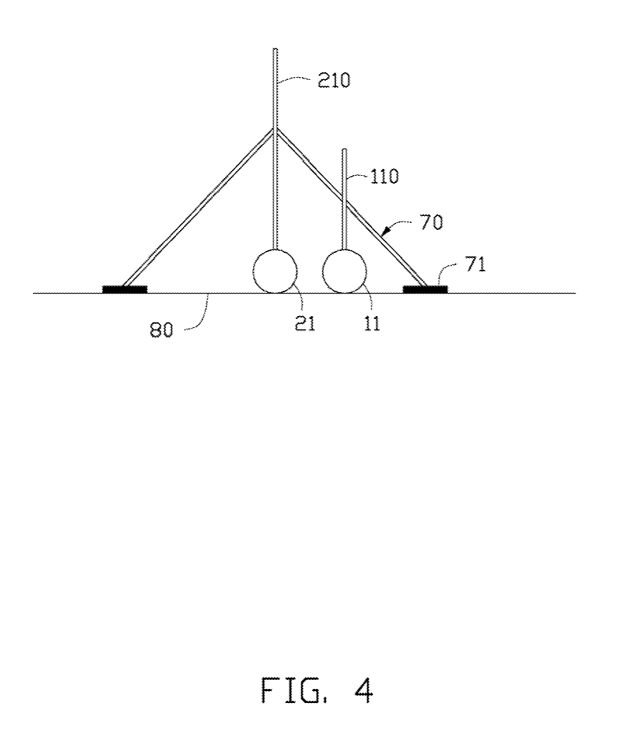

Referring to FIGS. 3-4, each of the plurality of shielding members 70 is substantially taper-shaped. A pair of absorbing plates 71 are located on bottom portions of each of the plurality of shielding members 70, for attaching the shielding members 70 on a smooth plane 80 (such as a desk or a wall). A first through hole 72 is defined in a top portion of each of the plurality of shielding members 70. A second through hole 73 is defined in a side portion of each of the plurality of shielding members 70. When the test system is testing light intensities of the LED module 10, the LED module 10 and the light sensor module 20 are placed on the plane 80. For example, when the test system is testing light intensities of the first LED 11, the first LED 11 and the first light sensor 21 are placed on the plane 80.

A signal line 210, connected to the first light sensor 21, extends through the first through hole 72 of the shielding member 70 to be exposed out of the shielding member 70. A power wire 110, connected to the first LED 11, extends through the second through hole 73 to be exposed out of the shielding member 70. The pair of absorbing plates 71 of the shielding member 70 are attached on the plane 80. The first LED 11 and the first light sensor 21 are thereby accommodated in the shielding member 70. In one embodiment, a diameter of the signal line 210 is substantially equal to a diameter of the first through hole 72, and a diameter of the power wire 110 is substantially equal to a diameter of the second through hole 73. The signal line 210 is configured to block the first through hole 72, and the power wire 110 is configured to block the second through hole 73 to close the shielding member 70, for preventing light emitting out of the shielding member 70 from interfering with light emitting from the first LED 11. The analog luminance signal generated by the first light sensor 21 is transmitted to the first AD converter 31 by the signal line 210. The power wire 110 is connected to a power supply (not shown), for supplying working voltage to the first LED 11. In some embodiments, the shielding members 70 can be other shapes and are made of opaque material.

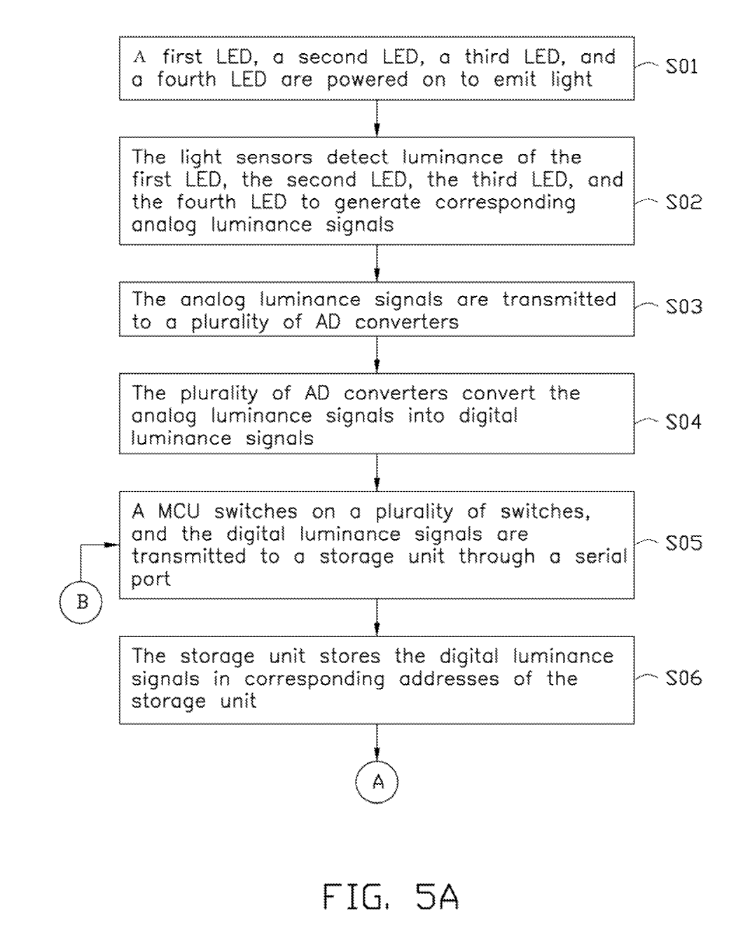

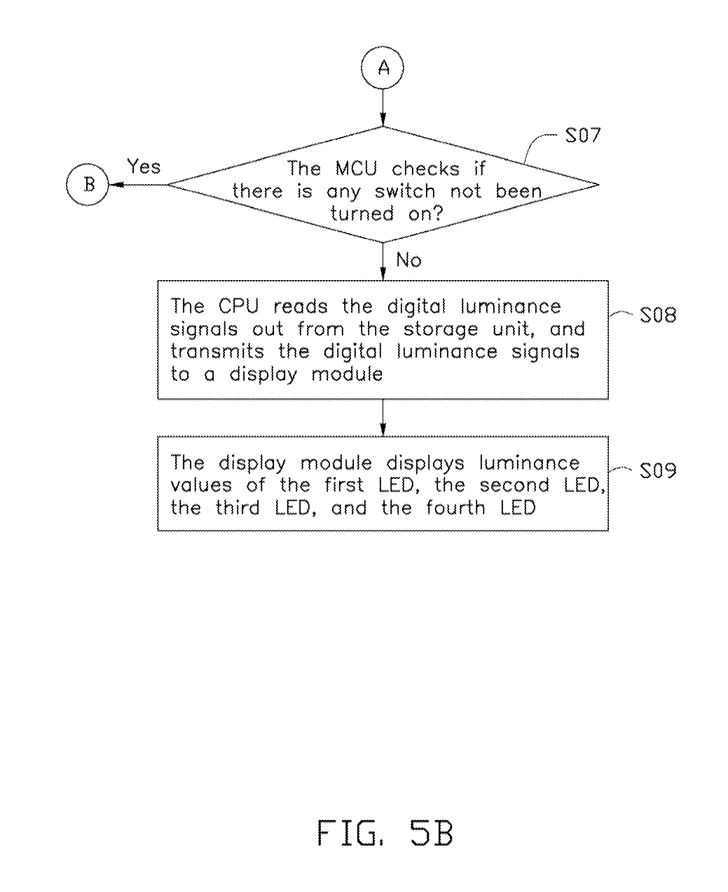

FIGS. 5A and 5B show an embodiment of a flow chart of a test method, which includes following steps:

In step S01 the first LED 11, the second LED 12, third LED 13, and the fourth LED 14 are powered on to emit light.

In step S02, the first light sensor 21 detects a luminance of the first LED 11 to generate a first analog luminance signal, the second light sensor 22 detects a luminance of the second LED 12 to generate a first analog luminance signal, the third light sensor 23 detects a luminance of the third LED 13 to generate a first analog luminance signal, and the fourth sensor 24 detects a luminance of the fourth LED 14 to generate a first analog luminance signal.

In step S03, the first analog luminance signal is transmitted to the first AD converter, the second analog luminance signal is transmitted to the second AD converter, the third analog luminance signal is transmitted to the third AD converter, and the fourth analog luminance signal is transmitted to the fourth AD converter.

In step S04, the first AD converter converts the first analog luminance signal into a first digital luminance signal, the second AD converter converts the second analog luminance signal into a second digital luminance signal, the third AD converter converts the third analog luminance signal into a third digital luminance signal, and the fourth AD converter converts the fourth analog luminance signal into a fourth digital luminance signal.

In step S05, the MCU 50 in turn switches the first switch 41, the second switch 42, the third switch 43, and the fourth switch 44 to be on. And then, the first digital luminance signal, the second digital luminance signal, the third digital luminance signal, and the fourth digital luminance signal is transmitted to the storage unit 52 in turn via the serial port 51.

In step S06, the storage unit 52 stores the first digital luminance signal, the second digital luminance signal, the third digital luminance signal, and the fourth digital luminance signal in corresponding addresses.

In step S07, the MCU 50 checks if all of the switches have been turned on, if yes, go to step S08, and if no, go to step S05.

In step S08, the CPU 53 reads the first digital luminance signal, the second digital luminance signal, the third digital luminance signal, and the fourth digital luminance signal from the storage unit 52, and transmits them to the display module 60.

In step S09, the display module 60 displays luminance values of the first LED 11, the second LED 12, the third LED 13, and the fourth LED 14 according to the first digital luminance signal, the second digital luminance signal, the third digital luminance signal, and the fourth digital luminance signal.

In another embodiment, more than four LEDs can be tested efficiently by using the test system and method.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A luminance test system, comprising:
a plurality of light-emitting diodes (LEDs);
a microcontroller;
a plurality of light sensors, each of the plurality of light sensors being configured to detect luminance of each of the plurality of LEDs to generate an analog luminance signal;
a plurality of shielding members, each of the shielding members being configured to receive each of the plurality of LEDs and each of the plurality of light sensors therein;
a plurality of analog to digital (AD) converters, each of the plurality AD converters being connected to each of the plurality of light sensors, and being configured to convert the analog luminance signal into a digital luminance signal;
a microcontroller (MCU) connected to the plurality of AD converters, the plurality of AD converters being configured to in turn transmit the digital luminance signal to the MCU;
a display module connected to the MCU, the display module being configured to display a luminance value of each of the plurality of LEDs according to the digital luminance signal.

2. The test system of claim 1, comprising a plurality of switches, each of the plurality of switches being connected between each of the plurality of AD converters and the MCU.

3. The test system of claim 2, wherein the MCU comprises a serial port connected to each of the plurality of AD converters, and the MCU is configured to control the plurality of switches so that only one of the plurality of switched is on and remaining of the plurality of switches are off at any time.

4. The test system of claim 3, wherein the MCU further comprises a storage unit connected to the serial port, and the storage unit is configured to store each of the digital luminance signal at a different address of the storage unit.

5. The test system of claim 4, wherein the MCU further comprises a central processing unit (CPU) connected to the storage unit, and the CPU is configured to read each of the digital luminance signal from the storage unit and transmit each of the digital luminance signal to the display module.

6. The test system of claim 1, wherein each of the plurality of light sensors is connected to each of the plurality of AD converters through a signal line, each of the plurality of shielding members defines a first through hole, and the signal line extends through the first through hole to be exposed out of each of the plurality of shielding members.

7. The test system of claim 6, wherein a diameter of the signal line is substantially equal to a diameter of the first through hole.

8. The test system of claim 1, further comprising a plurality of power wires, wherein each of the plurality of power wires is connected to each of the plurality of LEDs, each of the shielding members defines a second through hole, and each of the plurality of power wires extends through the second through hole of each of the plurality of shielding members to be exposed out of each of the plurality of shielding members.

9. The test system of claim 8, wherein a diameter of the power line is substantially equal to a diameter of the second through hole.

10. The test system of claim 1, wherein each of the plurality of shielding members is substantially taper-shaped.

11. The test system of claim 1, comprising a pair of absorbing plates on each of the plurality of shielding members, and each of the pair of absorbing plate being configured to be attached on a plane.

12. A luminance test method for a plurality of light-emitting diodes (LEDs), comprising:
powering on the plurality of LEDs to emit light;
detecting luminance of each of the plurality of LEDs to generate an analog luminance signal by each of a plurality of light sensors;
shielding each of the plurality of LEDs and each of the plurality of light sensors by each of a plurality of shielding members;
converting the analog luminance signal detected by each of the plurality of light sensors into a digital luminance signal by each of a plurality of analog to digital (AD) converters;
storing the digital luminance signal converted by each of the plurality of AD converters in a storage unit of a microcontroller (MCU); and
displaying a luminance value of each of the plurality of LEDs according to the digital luminance signal by a display module.

13. The test method of claim 12, further comprising connecting each of the plurality of AD converters to the MCU by each of a plurality of switches before the step of storing the digital luminance signal in the storage unit of the MCU.

14. The test method of claim 13, wherein the MCU comprises a serial port connected to each of the plurality of AD converters, and the MCU is configured to control the plurality of switches so that only one of the plurality of switched is on and remaining of the plurality of switches are off at any time.

15. The test method of claim 12, wherein each of the plurality of light sensors is connected to each of the plurality of AD converters through a signal line, each of the plurality of shielding members defines a first through hole, and the signal line extends through the first through hole to be exposed out of each of the plurality of shielding members.

16. The test method of claim 12, further comprising a plurality of power wires, wherein each of the plurality of power wires is connected to each of the plurality of LEDs, each of the plurality of shielding members defines a second through hole, and each of the plurality of power wires extends through the second through hole of each of the plurality of shielding members be exposed out of each of the plurality of shielding members.

17. The test method of claim 12, wherein each of the plurality of shielding members is substantially taper-shaped.

18. The test method of claim 12, wherein a pair of absorbing plates is located on each of the plurality of shielding members, and each of the pair of absorbing plate is configured to be attached on a plane.

19. The test method of claim 12, wherein the storage unit is adapted to store each of the digital luminance signal at a different address of the storage unit.

20. The test method of claim 12, wherein the MCU comprises a central processing unit (CPU) connected to the storage unit, the test method further comprises reading each of the digital luminance signal from the storage unit and transmit each of the digital luminance signal to the display module by the CPU before the step of displaying the luminance value by the display module.
